(19) United States
(12) Patent Application Publication
(10) Pub. No.: US 2009/0194973 A1
(43) Pub. Date: Aug. 6, 2009

(54) Foldable baby stroller

(76) Inventor: Kun Wang, Taichung (TW)

Correspondence Address: Wang, Kun, P.O. Box 44-2049, Taipei, 10668, TW

(21) Appl. No.: 12/010,907

(22) Filed: Jan. 31, 2008

(51) Int. Cl. B62B 7/06

(52) U.S. Cl. 280/642

(57) ABSTRACT

A baby stroller includes a first frame, a second frame, and two third frames with front wheels connected to two ends of the first frame by two pivotable members. The second frame with rear wheels are connected to the third frames. A handle is connected to the third frame and a seat is connected to the third frames and the second frame. A folding unit is used to pivot the first frame inward and an operation unit includes a rotation member which is operated to fold the handle. An adjustment unit adjusts the seat. A shade frame is connected to the seat and can extend or fold a fabric connected on the shade frame.

### BACKGROUND OF THE INVENTION

(1) Field of the Invention

The present invention relates to a baby stroller with foldable mechanism to fold the seat, the shade and the stroller includes a shock absorbing front wheels.

(2) Description of the Prior Art

A conventional baby stroller generally includes a foldable feature which includes a folding seat or shade, or has shocking absorbing front wheels. However, most of the existed baby strollers can only include one or two foldable functions and the foldable function are made by complicated mechanism which is not easily to be operated and manufactured.

The present invention intends to provide a baby stroller which can adjust the angles of the seat, the shade and includes shock absorbing front wheels by simple mechanisms.

### SUMMARY OF THE INVENTION

The present invention relates to a baby stroller and comprises a first frame, a second frame, two third frames, a handle and a seat. The first frame is connected with front wheels and the second frame is connected with rear wheels. Two third frames are connected to two ends of the first frame by two pivotable members and the second frame is pivotably connected to the third frames by two U-shaped members. The handle is connected to the third frames and two reception members are connected to the third frames. A seat has two insertions on two sides thereof and the two insertions are removably connected to the reception members. A folding unit includes a sleeve connected to each of the third frames and an inner member which is located in each of the third frames and engaged with the first frame. A rope is connected between the sleeve and the inner member. The inner tube is disengaged from the first frame by pulling the sleeve so that the first frame is pivotable inward. An operation unit includes a rotation member on the handle and a locking unit. The locking unit is connected with two ropes and includes a pin which is moved by rotating the rotation member to disengage the handle from the operation unit. An adjustment unit is located between the insertions of the seat and the two sides of the seat. The adjustment unit includes a press board and a gear. Each side of the seat includes a toothed recess with which the gear is engaged. The gear is removed from the toothed recess by pressing the press board so as to adjust the seat inward. A shade frame is connected to the seat and a fabric is connected on the shade frame. The shade frame together with the fabric are foldable and extendable.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the baby stroller of the present invention;

FIG. 2 is a side view of the baby stroller of the present invention;

FIG. 3 is an exploded view to show the folding unit of the baby stroller of the present invention;

FIG. 4 is an exploded view to show the inner member of the folding unit;

FIG. 5 is a partial cross sectional view to show that the inner member is connected to the first frame of the baby stroller of the present invention;

FIG. 6 is a partial cross sectional view to show that the inner member is disengaged from the first frame of the baby stroller of the present invention;

FIG. 7 is a partial cross sectional view to show that the first frame is pivotable relative to the third frame of the baby stroller of the present invention;

FIG. 8 is a cross sectional view to show the rotation member of the operation unit of the baby stroller of the present invention;

FIG. 9 is a cross sectional view to show the inner tube of the handle of the baby stroller of the present invention;

FIG. 10 is a cross section view to show the rotation member of the operation unit from another angle;

FIG. 11 is an exploded view to show the locking unit of the baby stroller of the present invention;

FIG. 12 is a cross sectional view to show locking unit;

FIG. 13 is a cross sectional view along line 13-13 in FIG. 12;

FIG. 14 shows that the pin of the locking unit is disengaged from the positioning hole in the third frames;

FIG. 15 shows that the baby stroller of the present invention is in folded status;

FIG. 16 is an exploded view to show the front wheels;

FIG. 17 is a partial cross sectional view to show the front wheels;

FIG. 18 is an exploded view to show the adjustment unit of the baby stroller of the present invention;

FIG. 19 is a cross sectional view to show the adjustment unit of the baby stroller of the present invention;

FIG. 20 is a partial cross sectional view to show that the press board is connected to the seat;

FIG. 21 is a partial cross sectional view to show that the press board is disengaged from the hook of the reception member;

FIG. 22 is an exploded view to show the shade frame of the baby stroller of the present invention;

FIG. 23 is a perspective view to show the shade frame;

FIG. 24 shows that a fabric is connected onto the shade frame;

FIG. 25 is a side cross sectional view to show the shade frame;

FIG. 26 shows that the two-sided member is disengaged from the toothed tube and the toothed sleeve, and

FIG. 27 is a cross sectional view to show the shade frame and the fabric.

### DETAILED DESCRIPTION OF THE PREFERRED EMBODIMENT

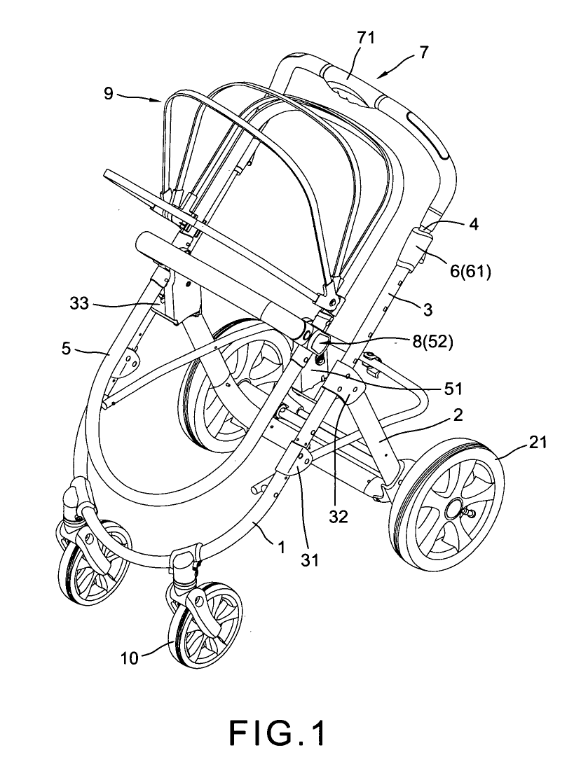

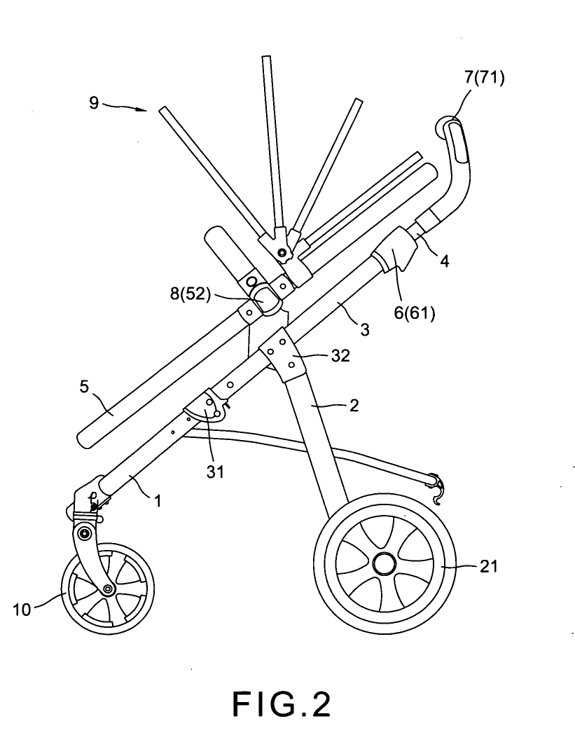

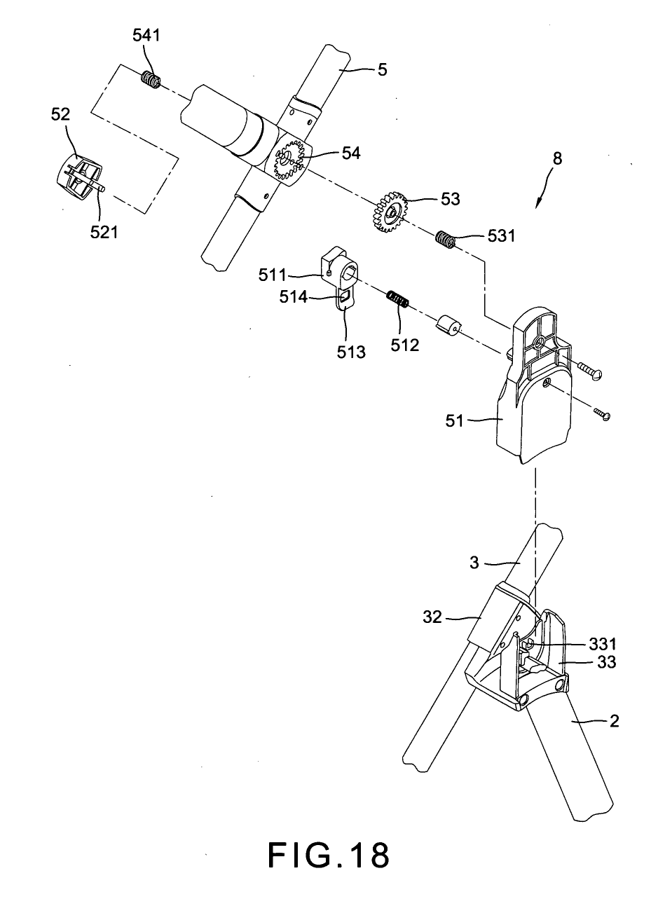

Referring to FIGS. 1 and 2, the baby stroller of the present invention comprises a U-shaped first frame 1 with front wheels 10 connected thereto, a U-shaped second frame 2 with rear wheels 21 connected thereto and two third frames 3 connected to two ends of the first frame 1 by two U-shaped pivotable members 31 and the second frame 2 is pivotably connected to the third frames 3 by two U-shaped members 32. A handle 4 is connected to the third frames 3 and two reception members 33 are connected to the third frames 3. A folding unit 6, an operation unit 7, an adjustment unit 8 and a shade frame 9 are connected to the baby stroller and will be described later. A seat 5 has two insertions 51 on two sides thereof and the two insertions 51 (FIG. 18) are removably connected to the reception members 33, such that the third frames 3 can be pivoted relative to the second frame 2.

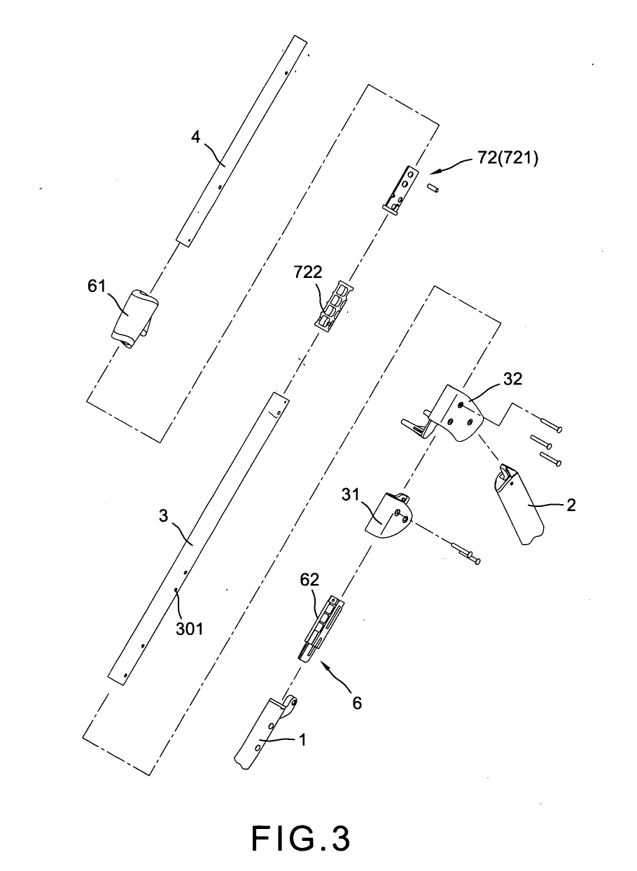

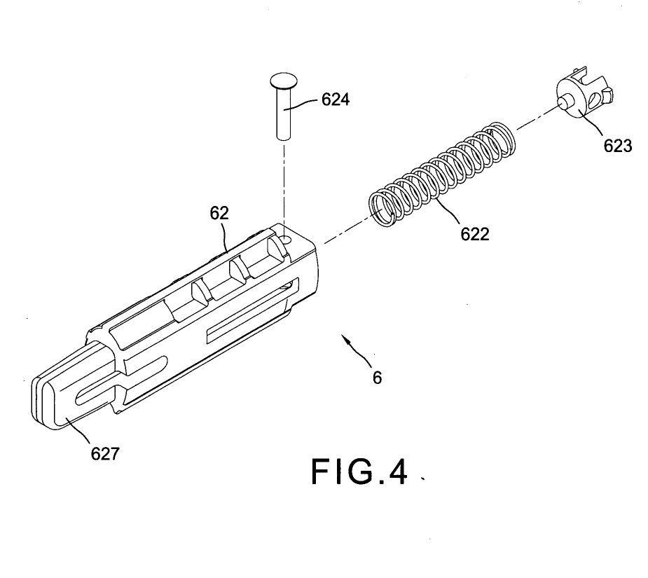

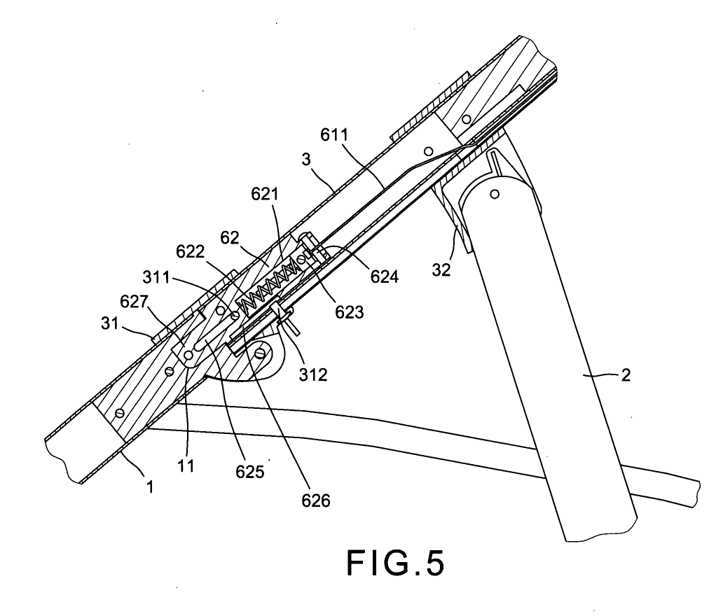

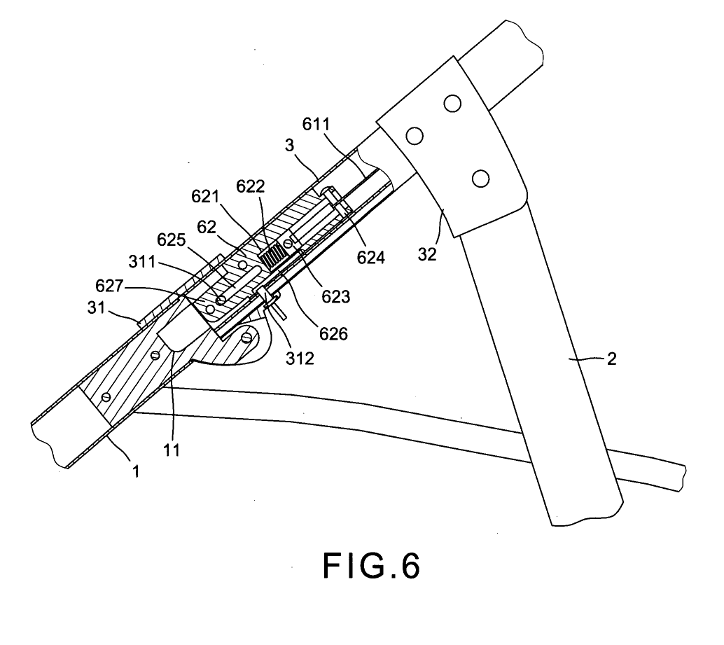

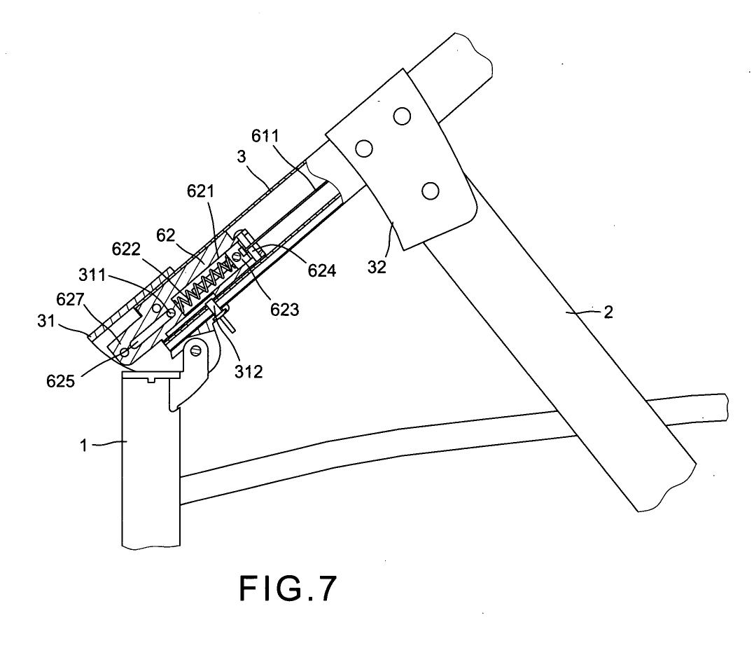

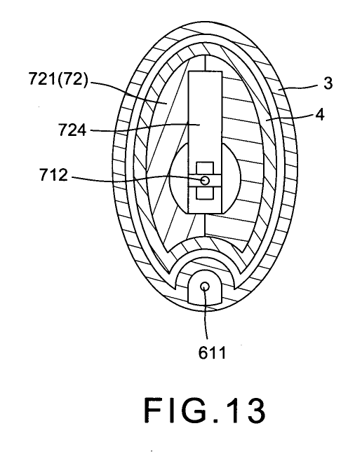

The folding unit 6 as shown in FIGS. 3 to 7 and 13, includes a sleeve 61 connected to each of the third frames 3 and an inner member 62 which is located in each of the third frames 3 and engaged with the first frame 1. The inner member 62 includes a recess 621 (FIGS. 5 and 6) in which a spring 622 is received. The spring 622 contacts a positioning member 623 in the inner member 62 and the spring 622 can move the inner member 62 to its initial position. A pin 624 is connected to the inner member 62 and the sleeve 61 is connected with a rope 611 which is secured to the pin 624 of the inner member 62. An elongate hole 625 is defined in the inner member 62 and a restriction slot 626 of limited length is defined around the inner member 62. The pivotable member 31 includes a rod 311 and a pin 312. The rod 311 is engaged with the elongate hole 625 and the pin 312 is engaged with the restriction slot 626. A distal end 627 of the inner member 62 is inserted into a recess 11 defined in the first frame 1. When pulling the sleeve 61, the rope 611 moves the inner member 62 upward which is disengaged from the recess 11 of the first frame 1 such that the first frame 1 can be pivoted inward.

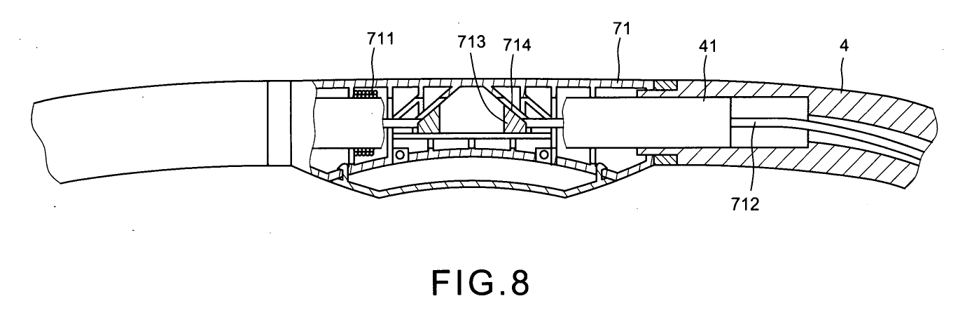

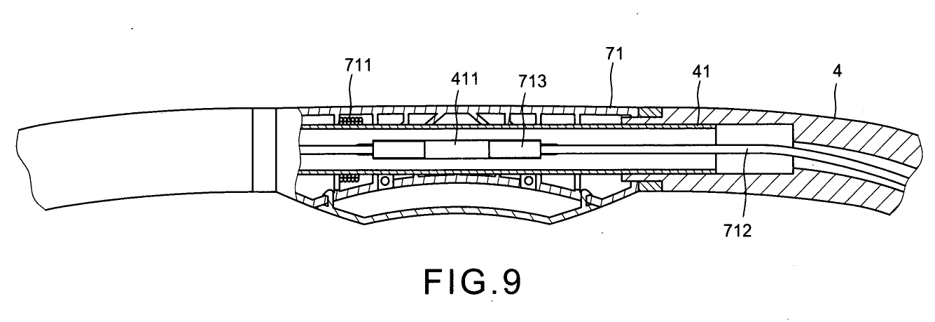

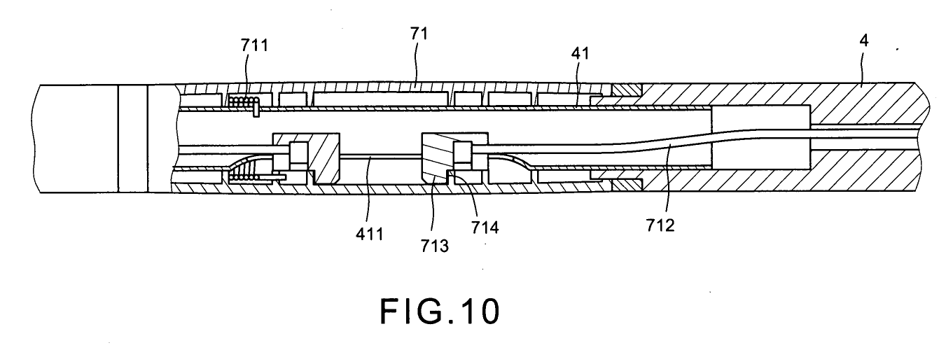

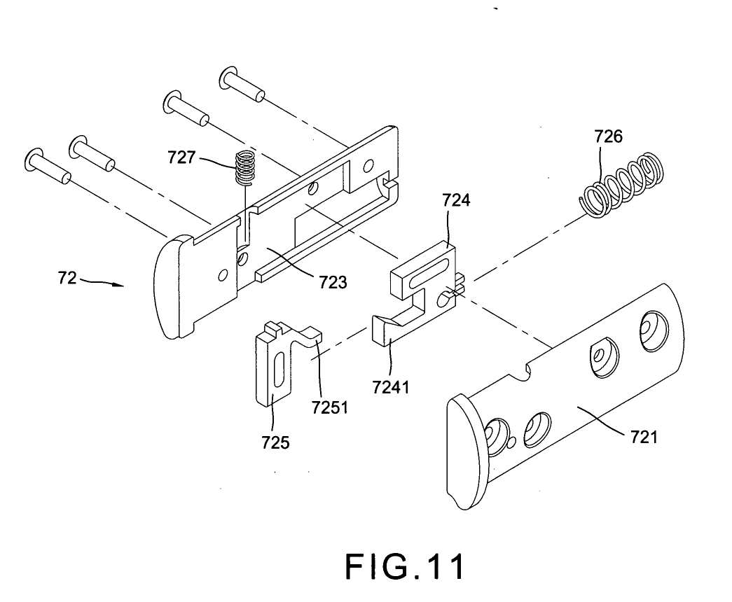

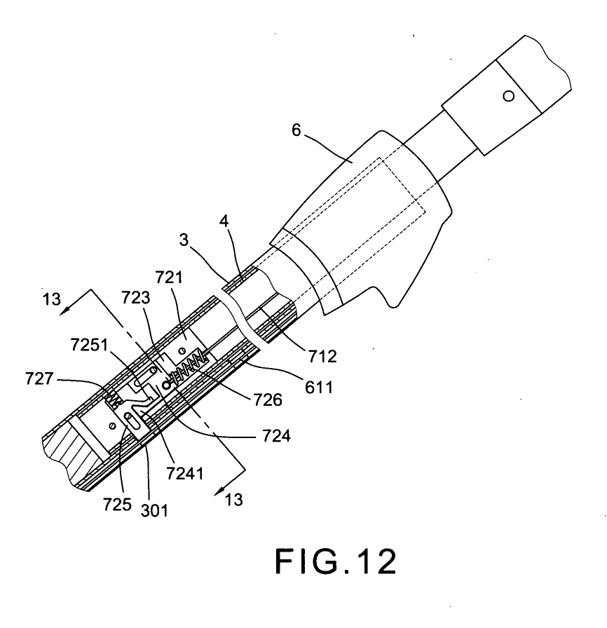

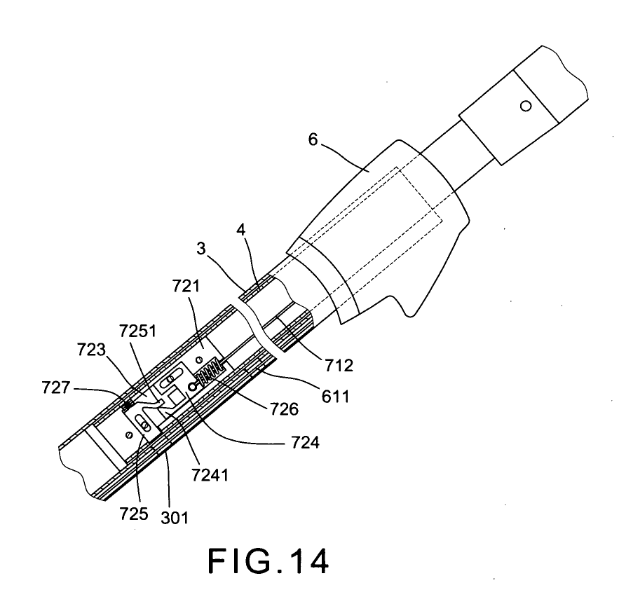

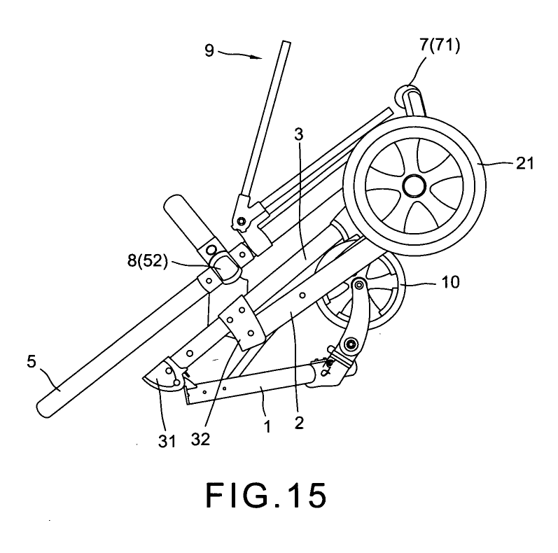

The operation unit 7 as shown in FIGS. 1, 3, 8 to 15, includes a rotation member 71 on the handle 4 and a locking unit 72, the locking unit 72 is located in the handle 4. The handle 4 includes a fixed inner tube 41 and the rotation member 71 is rotatably located in the fixed inner tube 41. The fixed inner tube 41 includes a slot 411 (FIG. 10) and an end of a coil spring 711 is connected to the inner tube 41. The other end of the coil spring 711 is engaged with the rotation member 71 so that the rotation member 71 can rotate back to its initial position by the coil spring 711. Two end pieces 713 on the two ropes 712 are engaged with the slot 411 so that the end pieces 713 can only moved within the slot 411. A triangle frame 714 is located in the rotation member 71 and is not located at the same plane, the triangle frame 714 is a curved member and the curvature matches with the curved profile of the rotation member 71. The triangle frame 714 is an isosceles triangle and the two end pieces 713 are located in the triangle frame 714. When the rotation member 71 is rotated, the triangle frame 714 drives the two end pieces 713 to move toward each other so as to pull the ropes 712. As shown in FIGS. 3, 11 and 13, the locking unit 72 includes a tubular member 722 and two half pieces 721 which are located in the handle 4. The tubular member 722 is located beneath the handle 4 and in the third frame 3. A space 723 is defined between the two half pieces 721 so as to receive a positioning board 724 and a pin 725 therein. The positioning board 724 has one end being biased by a spring 726 and connected with the rope 712 of the rotation member 71, the other end of the positioning board 724 includes a substantially triangular guide member 7241 extending therefrom to restrict the positioning board 724 to move transversely. The pin 725 is biased by a spring 727 and includes a curved extension 7251 which is in contact with the guide member 7241 to move the pin 725 longitudinally. A plurality of positioning holes 301 defined in the third frame 3 and the pin 725 is removably inserted into one of the positioning holes 301. When rotating the rotation member 71, the ropes 712 are pulled and the positioning board 724 is moved transversely so as to retract the pin 725 to disengage from the positioning hole 301 and the handle 4 can be moved within the third frame 3.

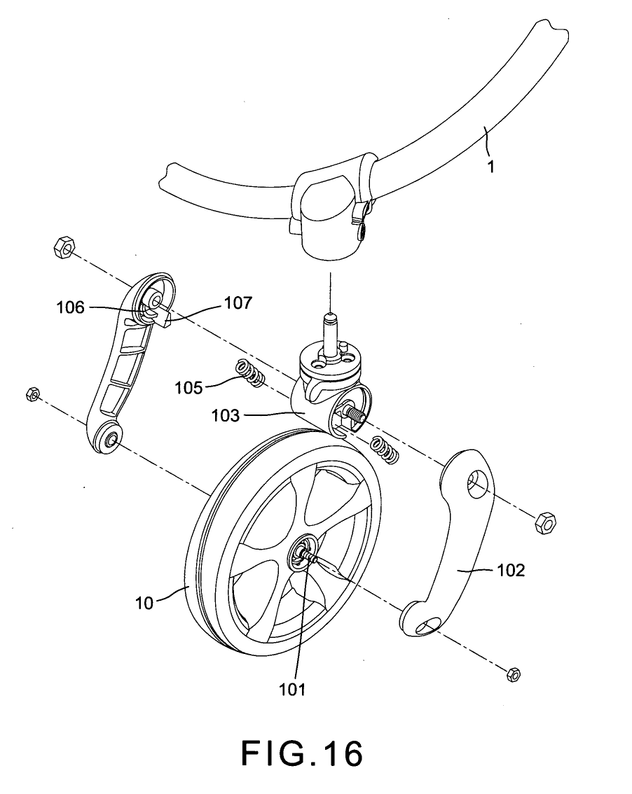

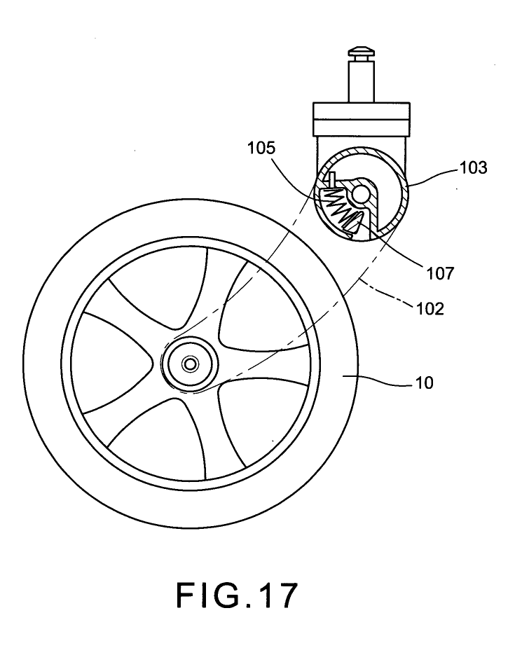

The front wheels 10 as shown in FIGS. 16 and 17 each include two arms 102 pivotably connected to an axle 101 thereof and a tubular member 103 is connected to the two rams 102. Two springs 105 are located on two ends of the tubular member 103. Each of the two arms 102 includes a pressing piece 106 and a block 107 on an end thereof facing the spring 105. The spring 105 is pressed by the block 107 and the pressing piece 106 positions the spring 105 and prevents the spring 105 from being twisted. The springs 105 are used as s shock absorbing means so that when the arms and the tubular member 103 have relative movement, the block 107 presses the spring 105 to absorb the shocks.

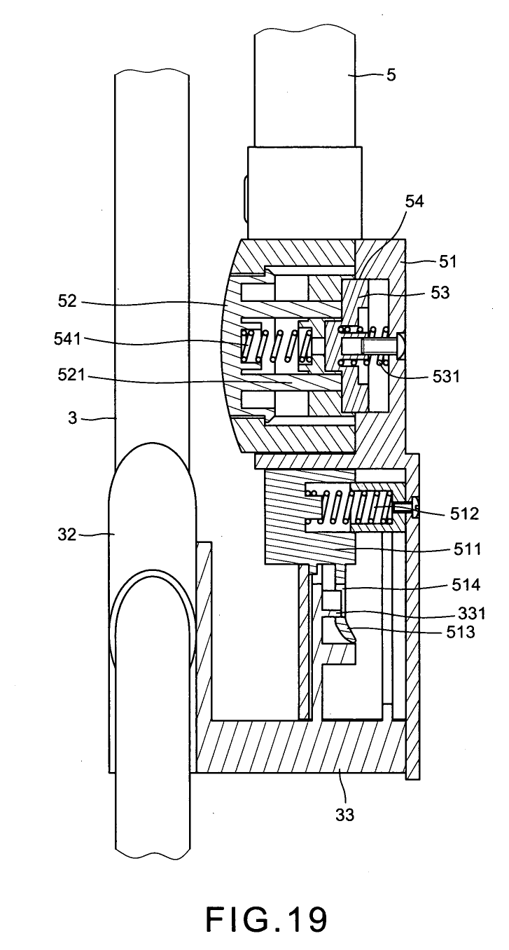

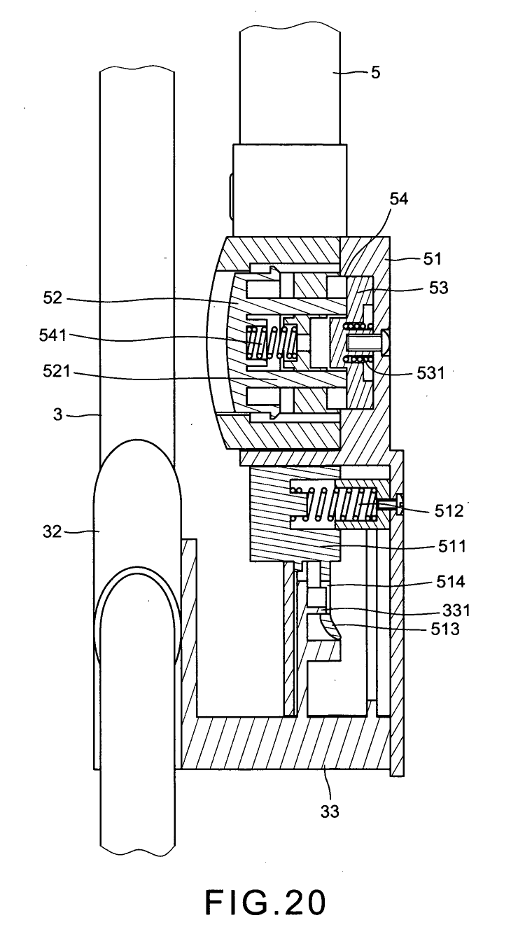

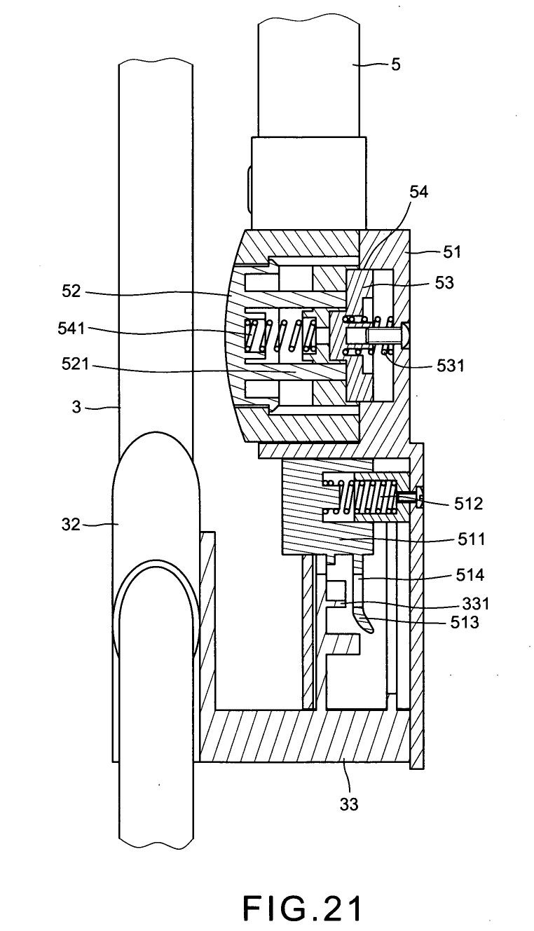

Referring to FIGS. 18 to 21, the adjustment unit 8 is located between the insertions 51 of the seat 5 and the two sides of the seat 5. The adjustment unit 8 includes a press board 52 and a gear 53, each side of the seat 5 includes a toothed recess 54 with which the gear 53 is engaged. The press board 52 contacts against a spring 541 and is engaged with the inside of the seat 5. The press board 52 includes two protrusions 521 which contact against the gear 53 which pushes another spring 531. The gear 53 and the spring 531 are located between the toothed recess 54 and the insertion 51. When pressing the press board 52, the two protrusions 521 push the gear 53 to disengage from the toothed recess 54 so that the seat 5 can be adjusted. The adjustment unit 8 includes a button 511 which is pivotably connected to the insertion 51 and biased by a spring 512. A spring plate 513 is connected to the button 511 and includes an engaging hole 514. A hook 331 is located in the reception member 33 so as to be engaged with the engaging hole 514. The press board 52 is pushed to move another spring 541 to contact the gear 53. The press board 52 is located on outside of the seat 5 and the insertion 51 is located at inside of the seat 5. The gear 53 is removed from the toothed recess 54 by pressing the press board 52 so as to adjust the seat 5.

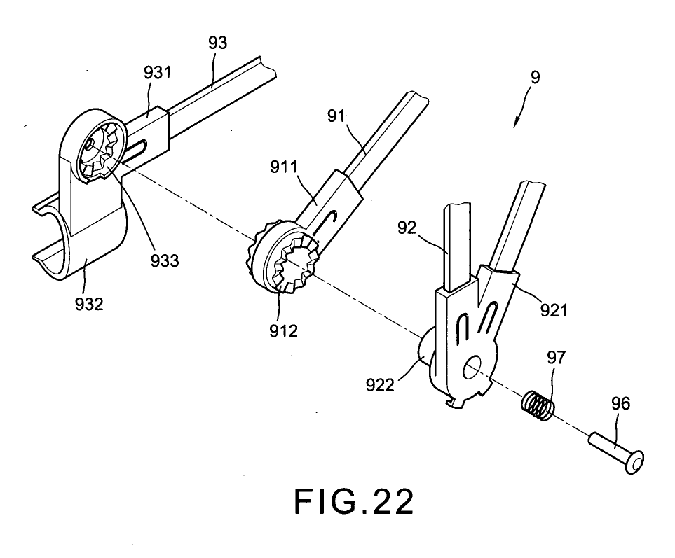

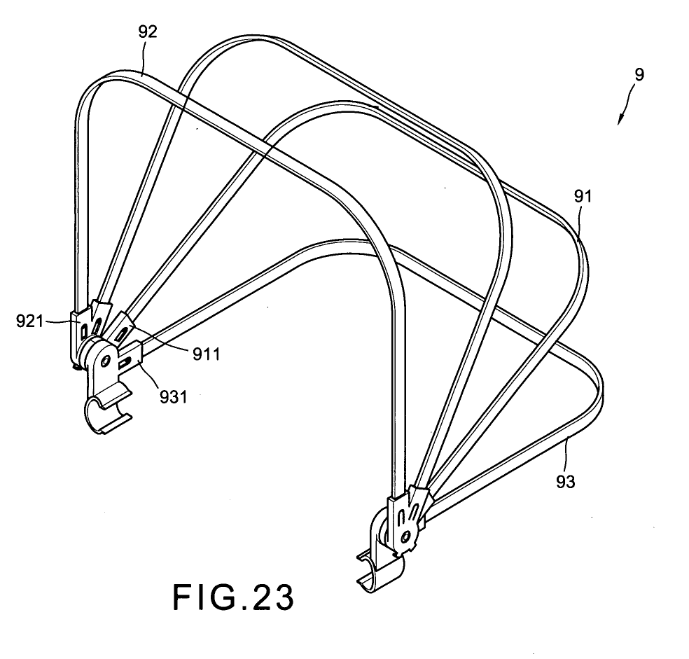

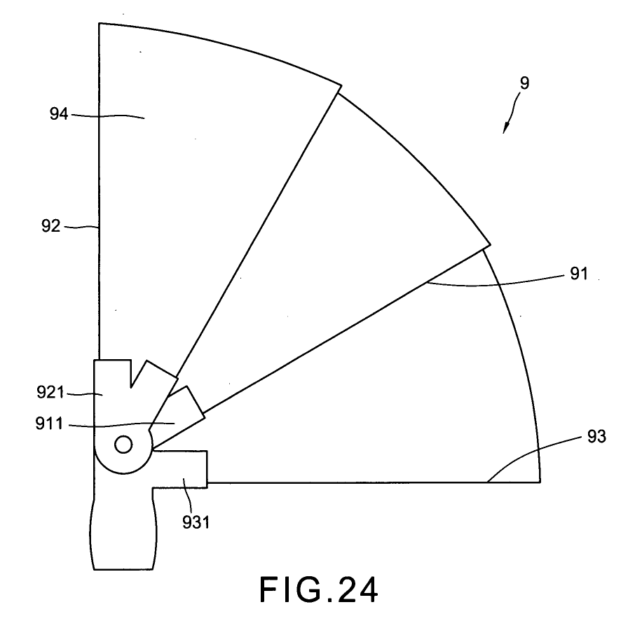

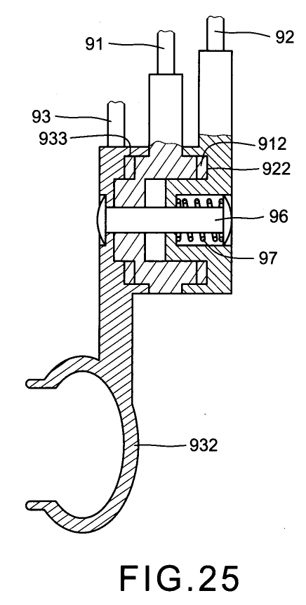

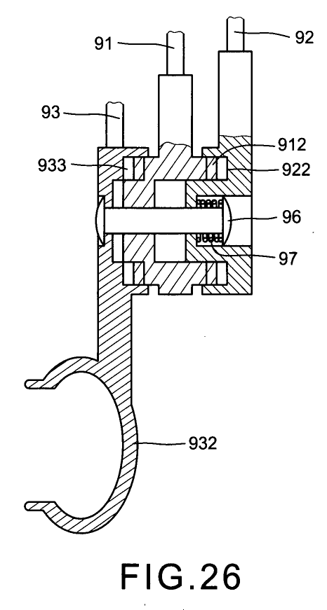

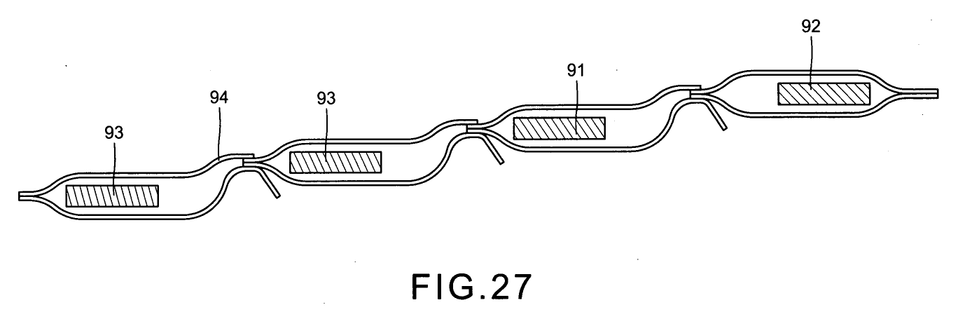

Referring to FIGS. 1, 22 to 27, the shade frame 9 is connected to the seat 5 and a fabric 94 connected on the shade frame 9. The shade frame 9 together with the fabric 94 are foldable and extendable. The shade frame 9 includes an intermediate frame 91, an outer frame 92 and an inner frame 93, the intermediate frame 91 is pivotably connected between the outer frame 92 and the inner frame 93. The intermediate frame 71 includes a first end member 911, the outer frame 92 includes two second end members 921 and the inner frame 93 includes a third end member 931. The inner frame 93 includes a clip 932. The fabric 94 is connected on the intermediate frame 91, the outer frame 92 and the inner frame 93. A toothed sleeve 933 is connected to an outside of the third end member 931 and two two-sided members 912 are connected on two ends of the first end member 911. A toothed tube 922 is connected to the second end member 921 and a spring 97 is received in the toothed tube 922. A pin 96 extends through the toothed tube 922 and the spring 97, the two-sided members 912 and the toothed sleeve 933 to connect the first, second and third end members 911, 921, 931. The toothed sleeve 933, the two sided members 912 and the toothed tube 922 ensure that the intermediate frame 91 and the outer frame 92 are positioned and do not pivot downward.

When folding the baby stroller, the user pulls the sleeve 61 to pull the rope 611 to move the inner member 62 upward, so that the inner member 62 is disengaged from the recess 11 of the first frame 1 so that the first frame 1 can be pivoted inward. The third frame 3 is pivoted about the second frame 2 by pressing the handle 4 downward, the second frame 2 is pivoted in the U-shaped member 32. The rotation member 71 is rotated to drive the rope 712 to move the positioning board 724 transversely and the pin 725 is disengaged from the positioning hole 301 such that the handle 4 can be retracted in the third frame 3.

The adjustment unit 8 is operated by pressing the press board 52 and the two protrusions 521 push the gear 53 out from the toothed recess 54 to adjust the seat 5. When releasing the press board 52, the press board 52 moves to its initial position and the gear 53 is engaged with the toothed recess 54 again to set the seat 5.

When operating the shade frame 9, the toothed tube 922 of the outer frame 92, the two-sided member 912 of the intermediate frame 91 and the toothed sleeve 933 of the inner frame 93 move relative to each other so that the inner and outer frames 93, 92 are folded or extended to set the fabric 94. The engagement between the toothed tube 922, the two-sided member 912 and the toothed sleeve 933 position the outer frame 92 and the intermediate frame 91.

When the baby stroller is applied by a downward force and moves on a bumpy road, the block 107 of the arms 102 presses the spring 105 as shown in FIG. 17 to provide a cushion feature.

While we have shown and described the embodiment in accordance with the present invention, it should be clear to those skilled in the art that further embodiments may be made without departing from the scope of the present invention.

What is claimed is:

1. A baby stroller comprising:
a first frame with front wheels connected thereto;
a second frame with rear wheels connected thereto;
two third frames connected to two ends of the first frame by two pivotable members and the second frame pivotably connected to the third frames by two U-shaped members, a handle connected to the third frames, two reception members connected to the third frames;
a seat having two insertions on two sides thereof and the two insertions are removably connected to the reception members;
a folding unit including a sleeve connected to each of the third frames and an inner member which is located in each of the third frames and engaged with the first frame, a rope connected between the sleeve and the inner member, the inner tube being disengaged from the first frame by pulling the sleeve so that the first frame is pivotable inward;
an operation unit including a rotation member on the handle and a locking unit, the locking unit connected with two ropes and including a pin which is moved by rotating the rotation member to disengage the handle from the operation unit;
an adjustment unit located between the insertions of the seat and the two sides of the seat, the adjustment unit including a press board and a gear, each side of the seat including a toothed recess with which the gear is engaged, the gear being removed from the toothed recess by pressing the press board so as to adjust the seat, and
a shade frame connected to the seat and a fabric connected on the shade frame, the shade frame together with the fabric being foldable and extendable.

2. The baby stroller as claimed in claim 1, wherein the inner member includes a recess in which a spring is received, the rope connected to the sleeve is secured to the inner member, an elongate hole is defined in the inner member and a restriction slot of limited length is defined around the inner member, the pivotable member includes a rod and a pin, the rod engaged with the elongate hole and the pin engaged with the restriction slot, a distal end of the inner member is inserted into a recess defined in the first frame.

3. The baby stroller as claimed in claim 1, wherein the handle includes a fixed inner tube and the fixed inner tube includes a slot and an end of a coil spring is connected to the inner tube, the other end of the coil spring is engaged with the rotation member, two end pieces on the two ropes are engaged with the slot, a triangle frame is located in the rotation member so that when the rotation member is rotated, the triangle frame drives the two end pieces to move toward each other, the locking unit includes a tubular member and two half pieces which are located in the handle and a space is defined between the two half pieces so as to receive a positioning board and a pin therein, the positioning board has one end being biased by a spring and connected with the rope of the rotation member, the other end of the positioning board includes a guide member extending therefrom to restrict the positioning board to move transversely, the pin is biased by a spring and includes a curved extension which is in contact with the guide member to move the pin longitudinally, a plurality of positioning holes defined in the third frame and the pin is removably inserted into one of the positioning holes.

4. The baby stroller as claimed in claim 1, wherein two arms are pivotably connected to an axle of each of the front wheels and a tubular member, two springs are located on two ends of the tubular member, each of the two arms includes a pressing piece and a block on an end facing the spring, the pressing piece positions the spring and the block presses the spring.

5. The baby stroller as claimed in claim 1, wherein the adjustment unit includes a button which is pivotably connected to the insertion and biased by a spring, a spring plate is connected to the button and includes an engaging hole, a hook is located in the reception member so as to be engaged with the engaging hole, the press board is pushed to move another spring to contact the gear, the press board is located on outside of the seat and the insertion is located at inside of the seat, the gear is removed from the toothed recess by pressing the press board so as to adjust the seat.

6. The baby stroller as claimed in claim 1, wherein the shade frame includes an intermediate frame, an outer frame and an inner frame, the intermediate frame is pivotably connected between the outer frame and the inner frame, the intermediate frame includes a first end member and the outer frame includes two second end members and the inner frame includes a third end member, the inner frame includes a clip, the fabric is connected on the an intermediate frame, the outer frame and the inner frame, a toothed sleeve is connected to an outside of the third end member and two two-sided members are connected on two ends of the first end member, a toothed tube is connected to the second end member and a spring is received in the toothed tube, a pin extends through the toothed tube and the spring, the two-sided members and the toothed sleeve to connect the first, second and third end members.
